(19) United States
(12) Patent Application Publication
(10) Pub. No.: US 2023/0252391 A1
(43) Pub. Date: Aug. 10, 2023

(54) METHOD AND SYSTEM FOR AUTOMATICALLY POINTING ON AN INFLUENCER ON A MEASURED PERFORMANCE CHANGE

(71) Applicant: NICE LTD., Ra'anana (IL)

(72) Inventors: Yuval Shachaf, Even Yehuda (IL); Gennadi Lembersky, Haifa (IL)

(21) Appl. No.: 18/122,131

(22) Filed: Mar. 16, 2023

Related U.S. Application Data
(63) Continuation-in-part of application No. 16/571,232, filed on Sep. 16, 2019.

(51) Int. Cl. G06Q 10/0639

(52) U.S. Cl. CPC G06Q 10/06393

(57) ABSTRACT

A computerized-method for automatically pointing on an influencer on a measured performance change is provided herein. The method may include: receiving one or more metrics from a user to construct a Key Performance Indicators (KPI); retrieving data related to one or more agents during a predefined period for the one or more metrics from one or more performance management databases; calculating a change in KPI; when the calculated change in KPI is negative: calculating an influence of each metric on the calculated change in KPI; calculating an influence of each agent on the calculated change in KPI; checking each agent having a negative change of a goal-accomplished-percentage to downgrade a contribution-factor of an agent having a top-negative-influence on the calculated change in KPI; and forwarding the downgraded contribution factor of the agent having the top-negative-influence on the calculated change in KPI to a downstream application.

### RELATED APPLICATION

This application is a continuation-in-part of U.S. patent application Ser. No. 16/571,232, filed Sep. 16, 2019.

### TECHNICAL FIELD

The present disclosure relates to the field of workforce optimization and to pointing and prioritizing focus on contact center challenges using artificial intelligence.

### BACKGROUND

Contact centers constantly strive to improve the amount of money each agent or team is earning on a per-hour basis over the course of days or weeks. For that purpose, agents' performance is monitored and recorded for later evaluation and rating. Moreover, contact centers maintain systems which bring together oceans of data from multiple sources across multiple dimensions and translates them into business goals. Commonly, via these systems the contact centers define one or more metrics to measure agent's performance. When a metric or a combination of metrics goes below a predetermined threshold the manager or supervisor is alerted on it for further action.

Even though each contact center is unique, agents' performance management is common, since every supervisor may face the same daily challenges such as, which agent has to be observed, which agent needs coaching and what is the best coaching approach to maximize the coaching utility.

A variety of Business Intelligence (BI) tools exist in the market to turn the oceans of data into meaningful information via, reports generators which are provided to decision makers. However, the design and creation of these reports require a lot of efforts and consumes business resources i.e., time, which translates into money. Therefore, to drive Workforce Optimization (WFO), i.e., to improve agents productivity and to identify performance gaps and deliver targeted coaching, it's imperative that the managers will be automatically directed to an influential dimension such as: agents, metrics, categories and interaction types, which is the most influencing on a decrease in performance so that the managers can focus their time and resources towards the most influential dimension rather than having the managers waste time in searching for the most impacting reason that is the root cause of the alert on the metric or the combination of metrics which went below a predetermined threshold.

Currently, there is no solution that provides an Artificial Intelligence (AI) solution such as an automated calculation of the influencers of the alert and prioritization thereof according to the level of influence on a predefined combination of metrics such as Key Performance indicators (KPI).

Furthermore, there is a need for a solution that will provide a user such as a manager or a supervisor, a deep analysis to determine which agent and/or category and/or interaction type and/or metric the supervisor should focus on to improve KPI or to reach a predefined KPI score.

Also, there is a need in a technical solution that will automatically provide the most effective coaching approach on the KPI score to reach a predefined KPI score by taking into account precalculated coaching effectiveness and having the business goals already reflected in the overall KPI calculation and check each agent having a negative change of a goal accomplished percentage, to downgrade a contribution factor of an agent having a top negative influence on the calculated change in KPI and forward the downgraded contribution factor of the agent having the top negative influence on the calculated change in KPI to a downstream application.

### SUMMARY

There is thus provided, in accordance with some embodiments of the present disclosure, a computerized method for automatically pointing on an influencer on a measured performance change.

In accordance with some embodiments of the present disclosure, the computerized method may comprise: (a) receiving one or more metrics from a user to construct a Key Performance Indicators (KPI); (b) retrieving data related to one or more agents during a predefined period for the one or more metrics from one or more performance management databases: (c) calculating a change in KPI; when the calculated change in KPI is negative: (d) calculating an influence of each metric on the calculated change in KPI; (e) calculating an influence of each agent on the calculated change in KPI; (f) checking each agent having a negative change of a goal accomplished percentage to downgrade a contribution factor of an agent having a top negative influence on the calculated change in KPI; and (g) forwarding the downgraded contribution factor of the agent having the top negative influence on the calculated change in KPI to a downstream application. The downstream application may be selected from at least one of: (1) Automatic Call Distributor (ACD) system for call routing; and (ii) Workforce Management (WFM) system for shift-scheduling of agents.

In accordance with some embodiments of the present disclosure, the computerized method may further comprise assigning a coaching session to the one or more agents to improve a metric having a highest negative influence on the calculated change in KPI.

In accordance with some embodiments of the present disclosure, optionally, presenting to a user via a display unit: (i) the calculated change in KPI; (ii) influence of each metric on the calculated change in KPI; and (iii) influence of each agent on the calculated change in KPI, and based on a precalculated coaching effectiveness suggesting a coaching approach to reach a predefined KPI goal.

In accordance with some embodiments of the present disclosure, based on a precalculated coaching effectiveness suggesting a coaching approach to reach a predefined KPI goal. The suggested coaching approach to reach a predefined KPI goal, which may be ‘92’, is the coaching approach that may advance the most current KPI towards the predefined KPI goal. For example, when the current KPI is ‘76’, the suggested coaching approach will be the one that will advance the KPI the most toward the predefined KPI goal.

In accordance with some embodiments of the present disclosure, a coaching approach to an agent by a metric may be a training session with the supervisor where the supervisor will go through the agent's interaction calls via a represented link to the agent's interaction calls. Another coaching approach may he a reference of the agent to a knowledge management system or a learning software to independently attend courses and learn information. Yet another coaching approach may be via trivia questions and answers presented to the agents. Yet another coaching approach may be peer coaching where the agent is associated with other agents which are having higher performance scores in the identified influencer.

In accordance with sonic embodiments of the present disclosure, the coaching is aimed to an agent, or a team of agents. The precalculated coaching effectiveness e.g., learning ability may be examined and measured during a predefined period of time and the result may be stored in a format of how each coaching hour may affect the KPI.

In accordance with some embodiments of the present disclosure, the measurements may be stored in the format of the influence of a time period e.g., one hour of coaching on the KPI.

In accordance with some embodiments of the present disclosure, the computerized method may calculate a KPI for a specified period by performing for each metric: a. receiving a weight; b. for each agent of the one or more agents: (i) harvesting a performance score based on the retrieved data during the specified period; (ii) calculating a percentage of each determined performance score out of a predefined goal-value in the specified period, to yield goal accomplished percentage; and (iii) storing the goal accomplished percentage in the one or more performance management databases, c. calculating an average goal accomplished percentage for all the agents during the specified period; and d. storing the average goal accomplished percentage for all agents in the one or more performance management databases. After performing all the calculations for each metric, the computerized method may be calculating a weighted sum of the one or more metrics based on the weight of each metric to yield the KPI.

In accordance with some embodiments of the present disclosure, the predefined period of the computerized method may include two specified periods: (i) past period and (ii) current period. When the predefined period includes the two specified periods, the computerized method may perform the calculating of the change in KPI by: a. calculating a KPI for the past period; b. calculating a. KPI for the current period; and c. subtracting the KPI of the past period from the KPI of the current period to yield the change in the KPI.

In accordance with some embodiments of the present disclosure, the computerized method may calculate the influence of each agent on the calculated change in KPI by performing for each agent: a. retrieving the goal accomplished percentage from the One or More performance Management databases for the past period and the current period; b. calculating the total positive change and the total negative Change between the retrieved past goal accomplished percentage and the retrieved current goal accomplished percentage; c. calculating a change of goal accomplished percentage by subtracting the retrieved past goal accomplished percentage from the retrieved current goal accomplished percentage. For each agent having a negative change of goal accomplished percentage, determining the percentage of a negative change out of the total negative change. For each agent having a positive change of goal accomplished percentage, determining the percentage of a positive change out of the total positive change.

In accordance with some embodiments of the present disclosure, the computerized method may further calculate the influence of each metric on the calculated change in KPI by performing for each metric; (i) retrieving the goal accomplished percentage for all agents from the one or more performance management databases for the past period and the current period; (ii) calculating a change of average goal accomplished percentage for all agents by subtracting the retrieved past goal accomplished percentage for all agents from the retrieved current goal accomplished percentage for all agents; (iii) calculating a weighted metric change for each metric by multiplying each change of average goal accomplished percentage for all agents with a predefined weight.

In accordance with some embodiments of the present disclosure, after the calculations for each metric, the computerized method may be calculating total negative change of goal accomplished percentage of all metrics having a negative change and calculating total positive change goal accomplished percentage of all metrics having a positive change. For each metric having a negative change of goal accomplished percentage, determining the percentage of a negative change out of the calculated total negative change; and for each metric having a positive change of goal accomplished percentage, determining the percentage of a positive change out of the calculated total positive change, to yield the influence of each metric on the calculated change in KPI.

In accordance with some embodiments of the present disclosure, the goal-value may be determined per at least one of: a predetermined period; an agent; a metric; a category; or an interaction type.

In accordance with some embodiments of the present disclosure, the performance score may be provided to at least one of: an agent; a metric; a category such as technical support, customer service, sales etc.; or an interaction type such as email, phone call, chat and the like.

In accordance with some embodiments of the present disclosure, the calculating of the change in KPI may be performed by Subtracting a KPI Of the predefined period from a predefined KPI-goal, based on the retrieved data. The retrieved data may be related to an agent, a metric a category or an interaction type.

In accordance with some embodiments of the present disclosure, the calculating of the influence of each agent on the calculated change in KPI may be further performed for each agent by: a. retrieving the goal accomplished percentage from the one. Or mote performance management databases for the predefined period; b. calculating a change by subtracting the retrieved goal accomplished percentage from the predefined KPI-goal; c. for each agent having a negative change of goal accomplished percentage, determining the percentage of a negative change out of the total negative change; and for each agent having a positive change of goal accomplished percentage, determining the percentage of a positive change out of the total positive change.

In accordance with some embodiments of the present disclosure, the calculating of the influence of each metric on the calculated change in KPI may be further performed for each metric by: (i) retrieving the average goal accomplished percentage for all agents from the one or more performance management databases for the predefined period; (ii) calculating a change of average goal accomplished percentage for all agents by subtracting the retrieved goal accomplished percentage from a predefined metric goal for all agents; and (iii) calculating a weighted metric change for each metric by multiplying each change of average goal accomplished percentage for all agents with a predefined weight.

In accordance with some embodiments of the present disclosure, after the calculations for each metric: calculating total negative change of goal accomplished percentage of all metrics having a negative change; and calculating total positive change goal accomplished percentage of all metrics having a positive change. For each metric having a negative change of goal accomplished percentage, determining the percentage of a negative change out of the calculated total negative change; and for each metric having a positive change of goal accomplished percentage, determining the percentage of a positive change out of the calculated total positive change, to yield the influence of each metric on the calculated change in KPI.

In accordance with some embodiments of the present disclosure, the computerized method may further comprise access to data related to the agent after retrieving the data from the one or more performance management databases. The retrieved data may include contact center interactions, such as voice call, chat, e-mails and the like and performance score of each agent in each metric and in each interaction type and each channel type.

In accordance with some embodiments of the present disclosure, each agent may be assigned a different weight for the calculating of the average goal accomplished percentage. Furthermore, each metric, category or interaction type may, be assigned a different weight for the calculating of the average goal accomplished percentage.

In accordance with some embodiments of the present disclosure, the computerized method may further comprise assigning a coaching session to the one or more agents to improve a metric having a highest negative influence on the calculated change in KPI.

There is further provided, in accordance with some embodiments of the present disclosure, a computerized system for automatically pointing on an influencer on a measured performance change is provided herein.

In accordance with sonic embodiments of the present disclosure, the system may comprise: a. one or more performance management databases; b. a memory to store the one or more performance management databases; c. a display unit; and d. a processor, that may be configured to: (i) receive one or more metrics from a user to construct a Key Performance Indicators (KPI); (ii) retrieve data related to one or more agents during a predefined period for the one or more metrics from one or more performance management databases; (iii) calculate a change in KPI; when the calculated change in KPI is negative: (iv) calculate an influence of each metric on the calculated change in KPI; and (v) calculate an influence of each agent on the calculated change in KPI; (vi) check each agent having a negative change of a goal accomplished percentage to downgrade a contribution factor of an agent having a top negative influence on the calculated change in KPI; and (vii) forward the downgraded contribution factor of the agent having the top negative influence on the calculated change in KPI to a downstream application. The downstream application may be selected from at least one of: (i) Automatic Call Distributor (ACD) system for call routing; and (ii) Workforce Management (WFM) system for shift-scheduling of agents.

In accordance with some embodiments of the present disclosure, optionally, after the calculations of the processor the computerized system may present to a user via a display unit: (i) the calculated change in KPI; (ii) influence of each metric on the calculated change in KPI; and (iii) influence of each agent on the calculated change in KPI and based on a precalculated coaching effectiveness suggesting a coaching approach to reach a predefined KPI goal.

In accordance with some embodiments of the present disclosure, the processor may be calculating a KPI for a specified period by performing for each metric: a. receive a weight; b. for each agent of the one or more agents: (i) harvesting a performance score based on the retrieved data during the specified period; (ii) calculating a. percentage of each determined performance score out of a predefined goal-value in the specified period, to yield goal accomplished percentage; and (iii) storing the goal accomplished percentage in the one or more performance management databases, c. calculating an average goal accomplished percentage for all the agents in the specified period: and d. storing the average goal accomplished percentage for all the agents in the one or more performance management databases.

In accordance with some embodiments of, the present disclosure, after the processor is performing the calculations for each metric, the processor may be calculating a weighted sum of the one or more metrics based on the Weight of each Metric to yield the KPI.

In accordance with some embodiments of the present disclosure, the predefined: period may include two specified periods: (i) past period and (ii) current period, and the processor may be configured to calculate the change in KPI by: calculating a KPI for the past period; calculating a KPI for the current period; and subtracting the KPI of the past period from the KPI of the current period to yield the change in the KPI.

In accordance with some embodiments of the present disclosure, the processor in the computerized system may he configured to calculate the influence of each agent on the calculated change in KPI by performing for each agent: (i) retrieving the goal accomplished percentage from the one or more performance management databases for the past period and the current period; (ii) calculating the total positive change and the total negative change between the retrieved past goal accomplished percentage and the retrieved current goal accomplished percentage; (iii) calculating a change of goal accomplished percentage by subtracting the retrieved past goal accomplished percentage from the retrieved current goal accomplished percentage. For each agent having a negative change of goal accomplished percentage, determining the percentage of a negative change out of the total negative change and for each agent having a positive change of goal accomplished percentage, determining the percentage of a positive change out of the total positive change.

In accordance with some embodiments of the present disclosure, the processor in the computerized system may be further configured to calculate the influence of each metric on the calculated change in KPI by performing for each metric: (i) retrieving the goal accomplished percentage for all agents from the one or more performance management databases for the past period and the current period; (ii) calculating a change of average goal accomplished percentage for all agents by subtracting the retrieved past goal accomplished percentage for all agents from the retrieved current goal accomplished percentage for all agents; and (iii) calculating a weighted metric change for each metric by multiplying each change of average goal accomplished percentage for all agents with a predefined weight.

In accordance with some embodiments of the present disclosure, after the calculations for each metric, the processor in the computerized system may be further configured to: (i) calculate total negative change of goal accomplished percentage of all metrics having a negative change; and (ii) calculate total positive change goal accomplished percentage of all metrics having a positive change. For each metric having a negative change of goal accomplished percentage, determining the percentage of a negative change out of the calculated total negative change; and for each metric having a positive change of goal accomplished percentage, determining the percentage of a positive change out of the calculated total positive change, to yield the influence of each metric on the calculated change in KPI.

In accordance with some embodiments of the present disclosure, the goal-value in the computerized system may be determined per at least one of: a predetermined period; an agent; a metric; a category; or an interaction type.

In accordance with some embodiments of the present disclosure, the performance score in the computerized system may be provided to at least one of an agent; a metric; a category such as technical support, customer service, sales, etc.; or an interaction type such as email, phone call, chat and the like.

In accordance with some embodiments of the present disclosure, the calculating of the change in KPI is performed by subtracting from KPI of the predefined period a predefined KPI-goal, based on the retrieved data. The retrieved data may be related to an agent, a metric a category or an interaction type.

In accordance with some embodiments of the present disclosure, the processor in the computerized system may be further configured to calculate the influence of each agent on the calculated change in KPI by performing for each agent: (i) retrieving the goal accomplished percentage from the one or more performance management databases for the predefined period; (ii) calculating a change by subtracting the retrieved goal accomplished percentage from the predefined KPI-goal. For each agent having a negative change of goal accomplished percentage, determining the percentage of a negative change out of the total negative change; and for each agent having a positive change of goal accomplished percentage, determining the percentage of a positive change out of the total positive change.

In accordance with some embodiments of the present disclosure, the processor in the computerized system may be further configured to calculate the influence of each metric on the calculated change in KPI by performing for each metric: (i) retrieving the average goal accomplished percentage for all agents from the one or more performance management databases for the predefined period; (ii) calculating a change of average goal accomplished percentage for all agents by subtracting the retrieved goal accomplished percentage from a predefined metric goal for all agents; and (iii) calculating a weighted metric change for each metric by multiplying each change of average goal accomplished percentage for all agents with a predefined weight.

In accordance with sonic embodiments of the present disclosure, after performing the calculations for each metric, the processor may be further configured to calculate total negative change of goal accomplished percentage of all metrics having a negative change; and calculate total positive change goal accomplished percentage of all metrics having a positive change. For each metric having a negative change of goal accomplished percentage, determining the percentage of a negative change out of the calculated total negative change; and for each metric having a positive change of goal accomplished percentage, determining the percentage of a positive change out of the calculated total positive change, to yield the influence of each metric on the calculated change in KPI.

In accordance with some embodiments of the present disclosure, the processor of the computerized system may be further configured to enable access to data related to the agent after retrieving the data from the one or more performance management databases and wherein the retrieved data includes: contact center interactions and performance score of each agent in at least one of the following dimensions: metric, interaction type and channel type.

In accordance with some embodiments of the present disclosure, each agent or metric or category or interaction type may be assigned a different weight for the calculating of the average goal accomplished percentage.

In accordance with some embodiments of the present disclosure, the processor may be further configured to assign a coaching session to the one or more agents to improve a metric having a highest negative influence on the calculated change in KPI.

### BRIEF DESCRIPTION OF THE DRAWINGS

For the present disclosure, to be better understood and for its practical applications to be appreciated, the following Figures are provided and referenced hereafter. It should be noted that the Figures are given as examples only and in no way limit the scope of the disclosure. Like components are denoted by like reference numerals.

FIG. 1 is a high-level diagram of the method for automatically pointing on an influencer a measured performance change, in accordance with some embodiments of the present disclosure;

FIGS. 2A-2B illustrate a flow chart of a method for automatically pointing on an influencer on a measured performance change, in accordance with some embodiments of the present disclosure;

FIG. 3 schematically illustrates a system for automatically pointing on an influencer on a measured performance change, in accordance with some embodiments of the present disclosure;

FIG. 4 is a snapshot of a dashboard presenting scores and trends of metrics of a KPI, in accordance with some embodiments of the present disclosure;

FIG. 5 is a snapshot of a dashboard presenting KPIs status and scores and trends of metrics of one of the KPIs, in accordance with some embodiments of the present disclosure; and

FIG. 6 is a table showing an example of a calculation of the influence of each metric on the calculated change in KPI, in accordance with some embodiments of the present disclosure.

### DETAILED DESCRIPTION

In the following detailed description, numerous specific details are set forth in order to provide a thorough understanding of the disclosure. However, it will he understood by those of ordinary skill in the art that the disclosure may he practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “metric” as used herein refers to a measure for quantitative assessment of agents. Metrics aid organizations to determine whether its goals are being achieved. For example, adherence to schedule, sentiment, empathy, service level, agents' satisfaction, sales volume, etc.

The term “performance management database” as used herein refers to databases which include performance parameters of agents during a specified period of tune. The performance parameters may be related to predefined metrics, categories or interaction types. The performance management database may also include voice recording databases having recorded calls e.g., interactions of agents with customers.

The term “goal-value” as used herein refers to a desired score in a metric or in a category or in an interaction type during a specified period.

The term “category” as Used herein refers to a department an organization such as sales, technical support, billing and the like.

The term “performance score” as used herein refers to a score attributed to an agent in a metric or in a category in a specific interaction type.

The term “Key Performance Indicators (KPI)” as used herein refers to a performance measurement comprised of one or more metrics. Each metric may be assigned a different weight according to its significance or contribution to the organization's goals.

The term “percentage goal accomplished” as used herein refers to a percentage of each determined performance score out of a predefined goal-value.

The term “interaction” as used herein refers to any type of communication of an agent with a customer in the contact center.

The term “sentiment score” as used herein refers to the rating of the language that has been used during an interaction. The rating is provided during an evaluation process based on the nature of the language if it has been mostly positive, negative, or neutral language.

The term “empathy score” as used herein refers to the rating of the ability to feel an appropriate emotion in response to others during au interaction. The rating is provided during au evaluation process.

The term “transfer rate” as used herein refers to the percentage of interactions handled by contact center representatives that has been transferred from one agent to another agent out of the total interaction dining a predetermined period of time.

The term “adherence to schedule” as used herein refers to a measurement that is used in contact centers which determines the amount of time during a shift that the agent has worked out of the total time of the shift. A contact center may consider time spent on breaks or doing other, non-contact related work.

The term “revenue per call” as used herein refers to how much a single contact is worth.

The term “self-assessment score” as used herein refers to agents' assessment of their own performance during interactions with customers.

In Contact Centers (CC)s the Quality of Service (QoS) is constantly measured. To that end agents' interactions with customers are recorded and at the end of each interaction the recording is being distributed for an evaluation process. During the evaluation process the agent is being rated according to predefined parameters such as sentiment score, empathy score, etc. The rating of the agents may be stored in performance management databases.

Thousands of agents working in the contact center may participate in various categories such as: customer service, technical support, sales, billing, etc. Each category may be attributed its own goals for the same matrices' measurements. For example, a metric measurement may be “Team Employee Engagement”. “Team Employee Engagement” may be a KPI that is constructed from six metrices including: sentiment score, empathy Store, transfer rate, adherence to schedule, revenue per contact and self-assessment score.

In a CC which monitors and calculates various KPIs during a specified time, when a user such as a manager or a supervisor would like to curve meaningful information out of the oceans of the aggregated data and for example to point on an influencer on a measured performance change, currently, the user has to use Business Intelligence (BI) solutions. However, operating these BI solutions might be time consuming and exhaust the user's resources in finding die problem instead. of investing the user's resources in implementing the solution.

Furthermore, systems such as Automatic Call Distributor (ACD) system and Workforce Management (WFM) system may improve the contact. center performance by using a technical solution that may provide an indication as to a calculated negative influence on the calculated change in KPI, during their routine processing.

Therefore, there is a need for an automatic calculation of the influencers of an alert on KPI change and their sorted level of influence according to their prioritization. The automatic calculation will provide the impact of each metric or agent or interaction type or category or combination thereof on the overall score e.g., KPI and will be based on a given effective coaching score.

Furthermore, there is a need for providing the most effective coaching approach on the KPI score to reach a predefined KPI score by having the business goals already reflected in the overall KPI calculation and taking into account precalculated coaching effectiveness and The business goals may be reflected in the KPI by embedded weight of the relevant dimensions such as: the agent or the metric or category or interaction type or any combination thereof.

Furthermore, even with deep analysis a user such as a supervisor can't determine which agent or interaction type or metric or category the user has to focus on for coaching purposes because even if the user retrieves the performance score of each segment and determines which one is the lowest, the user is not aware of the weight that the organization has attributed to each dimension such as: metric, interaction type, category or agent for the calculation of the overall KPI calculation. In addition, the user may not be aware of a precalculated coaching effectiveness that may be taken into consideration when considering a coaching approach that will best drive agents' performance towards a predefined KPI goal.

Therefore, there is a need for a computerized method and system for pointing on an influencer on a measured performance change such as KPI. The needed computerized method and system may base its calculations on precalculated coaching effectiveness which may be related to a coaching approach. The coaching approach may be, for example, a link to interactions recordings, knowledge management or courses, trivia questions to the agent, peer coaching, etc. The precalculated coaching effectiveness e.g., learning ability, may be examined and measured during a predefined period of time and the result may be stored in a format of how each coaching time period, e.g., one hour will affect the KPI.

The embodiments taught herein solve the technical problem of a negative influence on the calculated change in KPI which may be provided to a downstream application by forwarding a downgraded contribution factor of an agent having a top negative influence on the calculated change in KPI to a downstream application. The downstream application may be selected from at least, one of: (i) Automatic Call Distributor (ACD) system for call routing; and (ii) Workforce Management (WFM) system for shift-scheduling of agents.

The embodiments taught herein relating to contact interactions in a CC with contact interactions between a customer and an agent i.e., a CC representative is merely shown by way of example and technical clarity, and not by way of limitation of the embodiments of the present disclosure. The embodiments herein for automatically pointing on an influencer on a measured performance change may be applied on any customer service channel such as Interactive Voice Response (IVR) or mobile application. Furthermore, the embodiments herein are not limited to a CC but may be applied to any suitable platform providing customer service channels.

Furthermore, the embodiments taught herein relating to two dimensions of agents and metrics is merely shown by way of example and technical clarity, and not by way of limitation of the embodiments of the present disclosure. The embodiments herein may also relate to: (i) category, i.e., interaction type dimension such as sales, technical support, billing and the like and (ii) channel type dimension such as email, chat, phone call, Short Message Service (SMS) and the like.

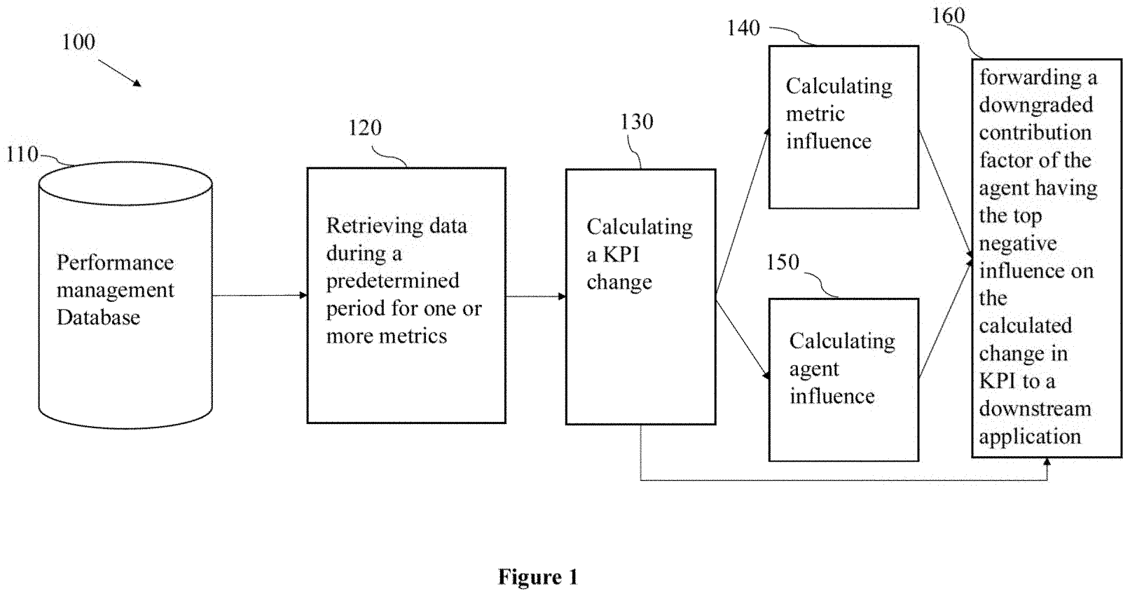

FIG. 1 is a high-level diagram of a method 100 for automatically pointing on an influencer on a measured performance change, in accordance with some embodiments of the present disclosure. The steps described herein below may be performed by a processor.

According to sonic embodiments of the present disclosure, one or more performance management databases such as performance management database 110 may store data related to agents' performance. The data may be imported from any type of source, business flows that manage the entire logic for auditing KPIs and coaching sessions. In a non-limiting example, the data sources may be Nexidia which is Customer Engagement Analytics Framework, Quality Control (QC) system,

Workforce Management (WFM) system, engagement management system, third-part systems, etc. The data may include all types of interactions such as screen and voice recordings, mails, chats, IVR data any contact and contact centers metrices, such as sentiment and adherence scores schedule adherence, survey scores, evaluation score, sales conversions rate, first contact resolution rate, hold time. number of transfers and the like.

According to some embodiments of the present disclosure, operation 120 may comprise retrieving data during predetermined period for one or more metrics from the one or more performance management databases such as performance management database 110. The retrieved metrics construct a Key Performance Indicators (KPI).

According to some embodiments of the present disclosure, the KPI may be a weighted average of metrices as shown in the following formula:

$$KPI = {\sum }_{i = 0}^{n} {W}_{i} {Metric}_{i} where 0 \leq {W}_{i} \leq 1 and {\sum }_{i = 0}^{n} {W}_{i} = 1$$

In accordance with some embodiments of the present disclosure, each agent of metric or category or interaction type may be assigned a. different weight for the calculating of the average goal accomplished percentage.

According to some embodiments of the present disclosure, a KPI for a specified period may be calculated for each metric by: a. receiving a weight; b. for each agent of the one or more agents: (i) harvesting a performance score based on the retrieved data during the specified period; (ii) calculating a percentage of each determined performance score out of a predefined goal-value in the specified period, to yield goal accomplished percentage; and (iii) storing the goal accomplished percentage in the one or more performance management databases. After the calculations for each metric, a. calculating an average goal accomplished percentage for all the agents during the specified period; and b. storing the average goal accomplished percentage for all agents in the one or more performance management databases. Then, calculating a weighted sum of the one or more metrics based on the weight of each metric to yield the KPI.

According to some embodiments of the present disclosure, operation 130 may comprise calculating a KPI change. In a non-limiting example, when the specified period includes two specified periods: (i) past period and (ii) current period, the KPI change may be calculated by comparing between previous and current period. The calculation of change in KPI may be performed as follows: calculating a KPI for the past period; calculating a KPI for the current period; and subtracting the KPI of the past period from the KPI of the current period to yield the change in the KPI.

According to some embodiments of the present disclosure, the goal-value may be determined per a predetermined period and/or per agent. According to some embodiments of the present disclosure, the goal-value of each one of the one or more metrics may be defined according to the service type of each category. For example, lengthy interaction might be rated poorly in technical service category but rated highly in sales category.

According to some embodiments of the present disclosure, when the calculated change in KPI is negative operation 140 may comprise calculating metric influence on KPI change. The calculation may be performed for each metric by: (i) retrieving the goal accomplished percentage for all agents from the one or more performance management databases for the past period and the current period (ii) calculating a change of average goal accomplished percentage for all agents by subtracting the retrieved past goal accomplished percentage for all agents from the retrieved current goal accomplished percentage for all agents; and (iii) calculating a weighted metric change for each metric by multiplying each change of average goal accomplished percentage for all agents with a. predefined weight.

According to some embodiments of the present disclosure, after the calculations for each metric, calculating total negative change of goal accomplished percentage of all metrics having a negative change, and calculating total positive change goal accomplished percentage of all metrics having a positive change. For each metric having a negative change of goal accomplished percentage, determining the percentage of a negative change out of the calculated total negative change, and for each metric having a positive change of goal accomplished percentage, determining the percentage of a positive change out of the calculated total positive change, to yield the influence of each metric on the calculated change in KPI.

According to some embodiments of the present disclosure, when the calculated change in KPI is negative operation 150 may comprise calculating agent influence on KPI change. The calculation may he performed for each agent by: retrieving the goal accomplished percentage from the one or more performance management databases for the past period and the current period; calculating the total positive change and the total negative change between the retrieved past goal accomplished percentage and the retrieved current goal accomplished percentage; calculating a change of goal accomplished percentage by subtracting the retrieved past goal accomplished percentage from the retrieved current goal accomplished percentage. For each agent having a negative change of goal accomplished percentage, determining the percentage of a negative change out of the total negative change and for each agent having a positive change of goal accomplished percentage, determining the percentage of a. positive change out of the total positive change.

According to some embodiments of the present disclosure, operation 160 may comprise forwarding a downgraded contribution factor of the agent having the top negative influence on the calculated change in KPI to a downstream application. The downstream application may be selected from at least one oft (i) Automatic Call Distributor (ACD) system for interactions or call routing; and (ii) Workforce Management (WFM) system for shift scheduling of agents.

According to some embodiments of the present disclosure, the downgraded contribution factor may be forwarded after a check of each agent having a negative change of a goal accomplished percentage and a downgrade of the contribution factor of an agent having a top negative influence on the calculated change in KPI.

According to some embodiments of the present disclosure, optionally the downgraded contribution factor may be forwarded only when the top negative influence is below a predefined threshold.

According to some embodiments of the present disclosure, the contribution factor may be a number in a specified range, for example, between ‘1’ and ‘10’, where ‘1’ is the lowest value and ‘10’ is the highest value. An agent having the lowest contribution factor which equals ‘1’, may not be downgraded beyond the lowest value, e.g., ‘1’.

According to some embodiments of the present disclosure, the ACD system may be using the contribution factor for routing purposes, i.e., routing an interaction to an agent. For example, when two or more agents are qualified to attend a pending interaction, i.e.. the agents are available and have the required skills, the ACD system may select the agent having the highest contribution factor.

According to some embodiments of the present disclosure, the WFM system may be using the contribution factor for shift-scheduling of agents. For example, when two or more agents have the same set of skills, the WFM system simulation to assign agents to a shift may use the contribution factor value of each agent to combine a balanced shift having agents with varied contribution factor value among other factors.

According to some embodiments of the present disclosure, optionally, assigning a coaching session to the one or more agents to improve a metric having a highest negative influence on the calculated change in KPI.

According to some embodiments of the present disclosure, optionally, presenting to a user via a display unit: (i) the calculated change in KPI; (ii) influence of each metric on the calculated change in KPI: and (iii) influence of each agent on the calculated change in KPI, and based on a precalculated coaching effectiveness suggesting a coaching approach to reach a predefined KPI goal.

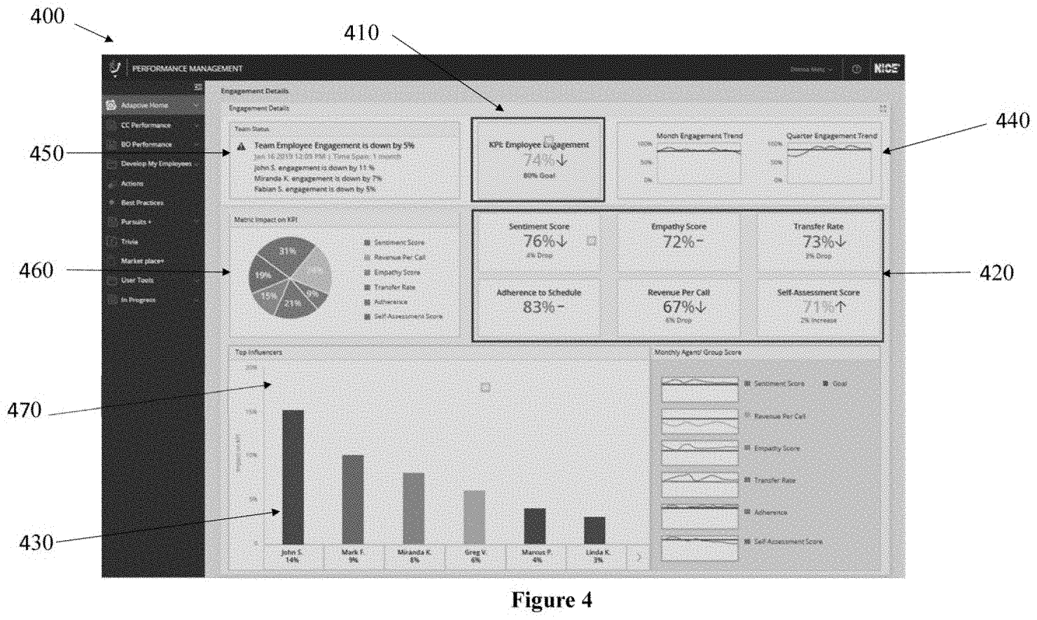

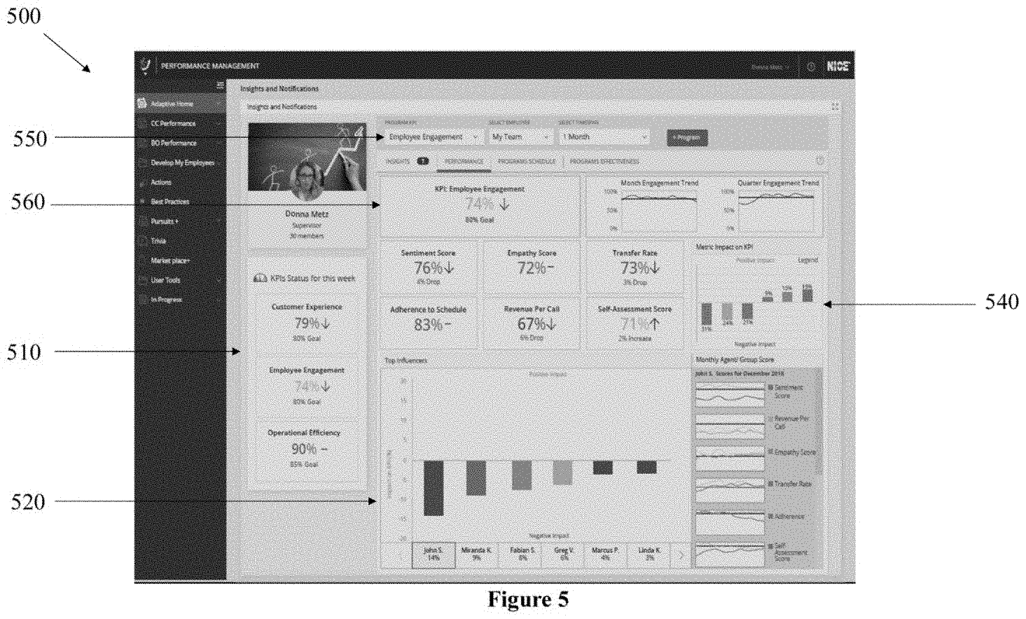

According to some embodiments of the present disclosure, optionally, displaying KPI change, metric influence and agent influence. The displaying may include custom dashboards and reports for both supervisor and agents. Examples of custom dashboards are described in detail in FIG. 4 and. FIG. 5.

According to some embodiments of the present disclosure, the interaction type influence and the interaction channel type influence may be also displayed to the user.

According to some embodiments of the present disclosure, a user such as manager or supervisor may have access to data related to the agent after retrieving the data from the one or more performance management databases.

According to some embodiments of the present disclosure, to eliminate influence of employees, e.g., inexperienced employees who haven't been successfully deployed yet in the organization, each agent may be assigned a different weight for the calculation of the fast and second average goal accomplished percentage.

According to some embodiments of the present disclosure, the goal accomplished percentage for a specified period, e.g., a week, may be an average of all KPIs across M dates, N agents and K categories and may be calculated according to the following formula:

$$goal accomplished percentage = 100 * \frac{{\sum }_{i = 0}^{N} {\sum }_{m = 0}^{M} {\sum }_{k = 0}^{K} KPI - {KPI\_Goal}_{M}}{N * M * K} ∀ N , M , K$$

whereby:
N is the number of agents,
M is the number of days in a date range,
K is the number of categories in a query.

According to some embodiments of the present disclosure, a change in goal accomplished percentage between two periods may be a deduction of previous goal accomplished percentage from current period goal accomplished percentage. For example.

Change%=Change%_{current_week}−Change%_{previous_week}

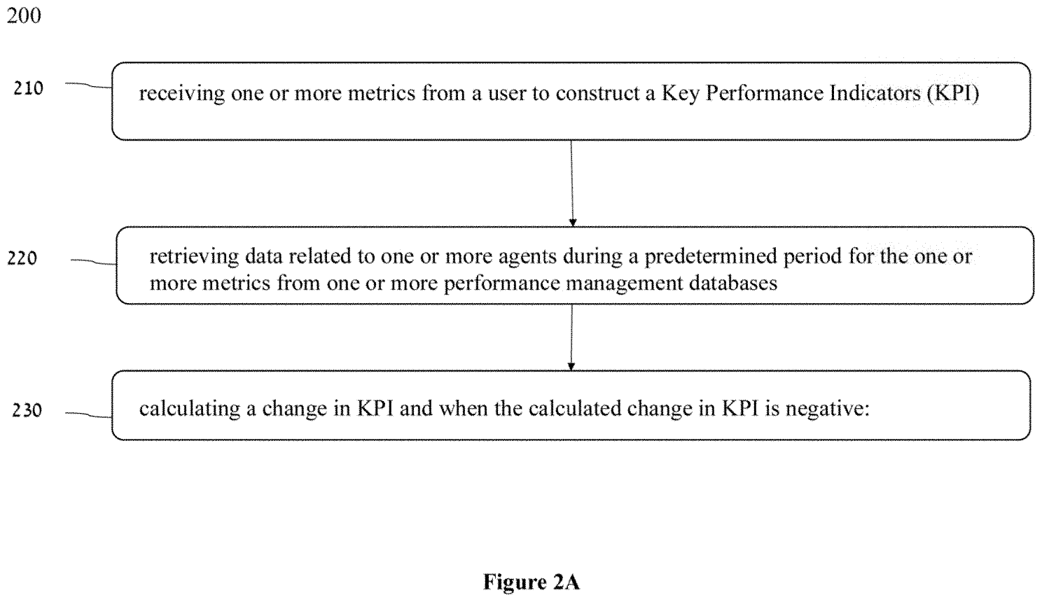

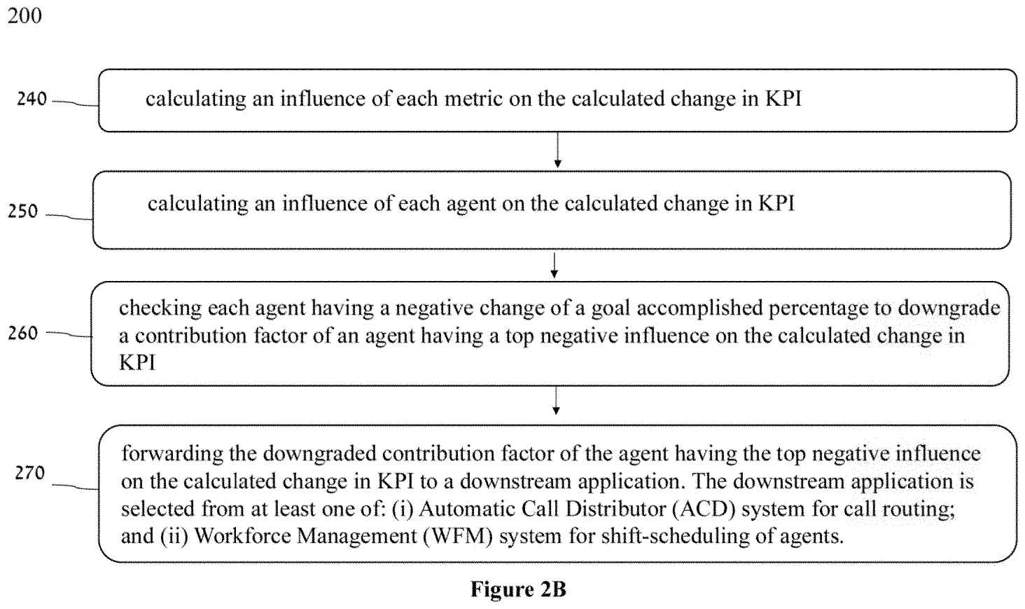

FIGS. 2A-2B illustrate a flow chart of a method for automatically pointing on an influencer on a measured performance change, in accordance with some embodiments of the present disclosure.

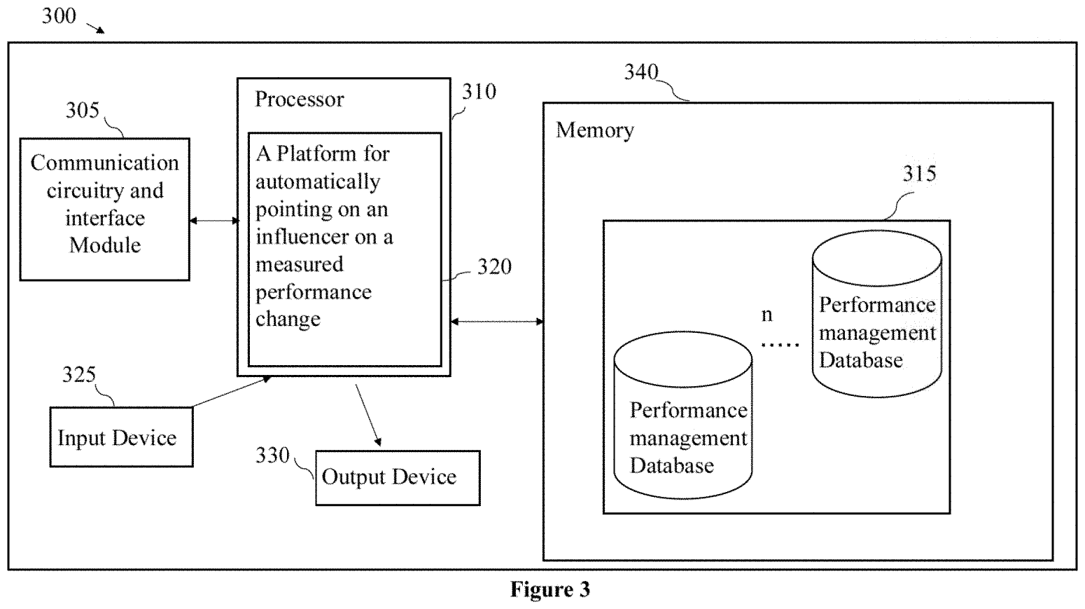

According to some embodiments of the present disclosure, method 100 in FIG. 1 and method 200 in FIG. 2 may implemented via a processor, a memory, an output device, an input device and communication circuitry and interface module for wired and/or wireless communication with any other computerized device over a communication network, as illustrated in FIG. 3, described hereinbelow.

According to some embodiments of the present disclosure, in a non-limiting example, a user may be a manager or a supervisor of a team of agents. The User may enter one or More metrics to formulate a KPI. For example, the metrics for employee engagement KPI may he sentiment score, revenue per call, empathy score, transfer rate, adherence to schedule and self-assessment score.

According to some embodiments of the present disclosure, the method 200 may use the processor and memory to retrieve data related to one or more agents during a past period and during a current period for the one or more metrics from one or more performance management databases.

According to some embodiments of the present disclosure, operation 210 may comprise receiving one or more metrics from a user to construct a Key Performance Indicators (KPI). The KPI may be in a non-limiting example, customer experience KPI, employee engagement KPI operational efficiency KPI and the like.

According to some embodiments of the present disclosure, operation 220 may comprise retrieving data related to one or more agents during a predetermined period for the one or more metrics from one or more performance management databases.

According to some embodiments of the present disclosure, the retrieved data may include voice recordings of agent's calls and performance score of each agent in each metric during the past and the current period.

According to some embodiments of the present disclosure, operation 230 may comprise calculating a change in KPI. In a non-limiting example, the change may he calculated by a comparison between KPI of past period and KPI of current period based on the retrieved data. In another non-limiting example, the calculating of the change in KPI may be performed by subtracting a KPI of a predefined period from a predefined KPI-goal, based on the retrieved data.

According to some embodiments of the present disclosure, the change in KPI may be positive and greater than a predefined threshold.

According to some embodiments of the present disclosure, the change in KPI may be increase, decrease or remain the same. Commonly, the organization is interested in a decrease in the KPI for coaching purposes. Therefore, according to some embodiments of the present disclosure, after the calculating of the change in KPI an alert may be presented on the change in the KPI to a user via the display unit.

According to some embodiments of the present disclosure, operations 240-270 may be performed when the calculated change in KPI is negative.

According to some embodiments of the present disclosure, operation 240 may comprise calculating an influence of each metric on the calculated change in KPI.

According to seine embodiments of the present disclosure, operation 250 may comprise calculating an influence of each agent on the calculated change in KPI.

According to some embodiments of the present disclosure, operation 260 may comprise checking each agent having a negative change of a goal accomplished percentage to downgrade a contribution factor of an agent having a top negative influence on the calculated change in KPI.

According to some embodiments of the present disclosure, operation 270 may comprise, forwarding the downgraded contribution factor of the agent having the top negative influence on the calculated change in KPI to a downstream application. The downstream application is selected from at least one of: (i) Automatic Call Distributor (ACD) system for call routing; and (ii) Workforce Management (WFM) system for shift-scheduling of agents.

In accordance with some embodiments of the present disclosure, optionally, based on a precalculated coaching effectiveness suggesting a coaching approach to reach a predefined KPI goal. The suggested coaching approach to reach a predefined KPI goal, which may be ‘92’, is the coaching approach that may advance the most current KPI towards the predefined KPI goal. For example, when the current KPI is ‘76’, the suggested coaching approach will be the one that will advance the KPI the most toward the predefined KPI goal.

In accordance with some embodiments of the present disclosure, a coaching approach to an agent by a metric may be a training session with the supervisor where the supervisor will go through the agent's interaction calls via a represented link to the agent's interaction calls. Another coaching approach may be a reference of the agent to a knowledge management system or a learning software to independently attend courses and learn information. Yet another coaching approach may be via trivia questions and answers presented to the agents. Yet another coaching approach may be peer coaching where the agent is associated with other agents which are having higher performance scores in the identified influencer.

In accordance with some embodiments of the present disclosure, the coaching is aimed to an agent, or a team of agents The precalculated coaching effectiveness e.g., learning ability may be examined and measured during a predefined period of time and the result may be stored in a format of how each coaching hour may affect the KPI.

In accordance with some embodiments of the present disclosure, the measurements may be stored in the format of the influence of a time period, e.g., one hour of coaching on the KPI score.

In accordance with some embodiments of the present disclosure, in a non-limiting example, an organization may be enabled, to choose to invest coaching time on the most effective agents even though their score is higher than others and they may have less room for improvement. The reason is that the coaching of the agents with lower scores might be less effective based on a precalculated coaching effectiveness to reach a predefined KPI goal. The organization may also be enabled to choose to invest coaching time on the most effective metric, category or channel type. In other words, based on past coaching effectiveness measurements results and the influence of at least one of the following dimensions: die agents, metric, category and channel type, the organization may decide for example, to invest coaching time in agents with higher scores rather than in agents with lower scores because their coaching may be more effective to reach the predefined goal.

FIG. 3 schematically illustrates a system 300 for automatically pointing, on an influencer on a measured performance change, in accordance with some embodiments of the present disclosure.

According to some embodiments of the present disclosure, method 100 in FIG. 1 and method 200 may be implemented via a processor 310, a memory 340, an input device 325, an output device 330, and a communication circuitry and interface module 305 for wired and/or wireless communication with any other computerized device or downstream application over a communication network.

According to some embodiments of the present disclosure, the processor 310 may be configured to operate in accordance with programmed instructions stored in memory 340 and may comprise one or more processing units, e.g., of one or more computers. The processor 310 may be further capable of executing a platform 320 pointing on an influencer on a measured performance (as described in method 200 with respect to FIGS. 2A-2B).

According to some embodiments of the present disclosure, the processor 310 may communicate with an output device such as output device 330. For example, the output device 330 may include a computer monitor or screen and the processor 310 may communicate with a screen of the output device 330. In another example, the output device 330 may include a printer, display panel, speaker, or another device capable of producing visible, audible, or tactile output.

According to some embodiments of the present disclosure, the processor 310 may further communicate with an input device such as input device 325 via platform 320. For example, the input device 325 may include one or more of a keyboard, keypad or pointing device for enabling a user to input data or instructions for operation of the processor 310. In a non-limiting example, a user such as a senior manager may enter via input device 325 one or more metrics to formulate a KPI. Another user such as a supervisor of a team of agents may be presented via the output device with a recommendation on an effective coaching task related to the metric that influenced the most on the negative change in KPI for the agent that influenced the most on the negative change in KPI. The user may be also presented via the output device with the change in KPI, the influence of each metric on the calculated change in KPI and the influence of each agent on the calculated change in KPI.

According to some embodiments of the present disclosure, a platform 320 for automatically pointing on an influencer on a measured performance change may retrieve data related to one or more agents during a past period and during a current period for the one or more metrics from one or more performance management databases 315.

According to some embodiments of the present disclosure, the processor 310 may further communicate with memory 340. The memory 340 may include one or more volatile or nonvolatile Memory devices. The Memory 340 may be utilized to store, for example, programmed instructions for operation of the processor 310, data or parameters for use by the processor 310 during operation, or results of the operation of the processor 310 For example, the memory 340 may store: one or more performance management databases 315 which include agents' performance data such as performance scores of agents during a specified time in a certain metric, interaction type or category, and recorded interactions of agents with customers such as voice call, chat, e-mails and the like.

According to some embodiments of the present disclosure, the platform 320 may be operated to retrieve data related to one or more agents during a predefined period for the one or more metrics from one or more performance management databases, then, when the calculated change in KPI is negative: calculate a change in KPI, calculate an influence of each metric on the calculated change in KPI and calculate an influence of each agent on the calculated change in KPI.

According to some embodiments of the present disclosure, the platform 320 may be further operated to check each agent having a negative change of a goal accomplished percentage to downgrade a contribution factor of an agent having a top negative influence on the calculated change in KPI and forward the downgraded contribution factor of the agent having the top negative influence on the calculated change in KPI to a downstream application. The downstream application may be selected from at least one of: (i) Automatic Call Distributor (ACD) system for call routing; and (ii) Workforce Management (WFM) system for shift-scheduling of agents.

According to some embodiments of the present disclosure, the ACD system may be using the contribution factor for routing purposes, i.e., routing an interaction to an agent. For example, when two of more agents are qualified to attend a pending interaction, i.e., the agents are available and have the required skills, the ACD system may, select the agent having the highest contribution factor.

According to some embodiments of the present disclosure, the WFM system may be using the contribution factor for shift-scheduling of agents. For example, when two or more agents have the same set of skills, the WFM system simulation to assign agents to a shift may use the contribution factor value of each agent to combine a balanced shift having agents with varied contribution factor value among other factors.

According to some embodiments of the present disclosure, optionally, the processor 310 may operate platform 320 for effective coaching by automatically pointing on an influencer on measured performance decrease to calculate a change in KPI. In a non-limiting; example, the calculation of the change in KPI may be performed by a comparison between KPI of past period and KPI of current period based on the retrieved data. In another non-limiting example, the change may be calculated by subtracting a KPI of a predefined period from a predefined KPI-goal, based on the retrieved data.

According to some embodiments of the present disclosure, the processor 310 may further use platform 320 to calculate the influence of each metric on the calculated change in KPI and to calculate an influence of each agent on the calculated change in KPI.

According to some embodiments of the present disclosure, the processor 310 may further use platform 320 to analyze the influence of each metric on the KPI score and the influence of each agent on the change in KPI to yield a recommendation on an effective coaching task related to the metric that influenced the most on the negative change in KPI for the agent that influenced the most on the negative change in KPI.

FIG. 4 is a snapshot 400 of a dashboard presenting scores and trends of metrics of a KPI, in accordance with some embodiments of the present disclosure.

According to some embodiments of the present disclosure, platform 320 in FIG. 3 may present via an output device 330 a decrease in a KPI. In a non-limiting example, the decreased KPI may be ‘team employee engagement’ KPI 450. The goal accomplished percentage of the decreased KPI is ‘74%’ as shown by element 410 and the goal percentage is ‘80%’. The vertical arrow in element 410 is demonstrating the decrease in the KPI. Monthly and quarterly trends are shown via element 440.

According to some embodiments of the present disclosure, platform 320 in FIG. 3 may receive one or more metrics to formulate a KPI. In a non-limiting example, the “team employee engagement” KPI has been formulated from six metrics as shown in element 420. For each metrics the goal accomplished percentage is presented and the nature of the change in the metric, e.g., drop, rise or neutral.

According to some embodiments of the present disclosure, the top influencers on the change in KPI may be presented via a bar graph as shown in element 470. The top agent influencers on the change in KPI may be presented as shown in element 430. The metric impact on the KPI score may be presented as shown in element 460.

FIG. 5 is a snapshot of a. dashboard 500 presenting KPIs status, scores and trends of metrics of one of the KPIs, in accordance with some embodiments of the present disclosure.

According to some embodiments of the present disclosure, a user such as supervisor may select a KPI such as ‘employee engagement’ for a specific time during a specified time span. Accordingly, a KPI score 560 ‘74%’, which is a weighted sum of One or more metrics based on the weight of each metric is shown. The KPI score is based on an average goal. accomplished percentage for all agents in the one or more performance management databases, (shown as element 315 in FIG. 3) The KPI score goal is also shown as ‘80%’.

According to some embodiments of the present disclosure, the KPI status for a certain week like the current week may be presented as shown by element 510. In the KPI status 510 the score of each KPI such as, ‘customer experience’, ‘employee engagement’ and ‘operational efficiency’ is presented. According to some embodiments of the present disclosure, the impact of each metric of the one or more metrics may be presented, as shown by element 540. According to some embodiments of the present disclosure, the impact of the top agent influencers on the KPI score may also be presented as shown by element 520.

According to some embodiments of the present disclosure, coaching effectiveness may be taken into consideration to point on an influencer on a measured performance change. The coaching effectiveness may be a KPI change following a one-hour coaching session. Therefore, the combination of the impact on Negative/Positive change with the coaching effectiveness, enables to point on the most influential agent with the highest potential to increase the overall KPI to reach a predefined KPI goal after a suggested coaching session. According to some embodiments of the present disclosure, the coaching session may be suggested out of various coaching approaches.

According to some embodiments of the present disclosure, each agent's coaching effectiveness is given and the impact on negative change has already been calculated prior to automatically pointing on an influencer on a measured performance change.

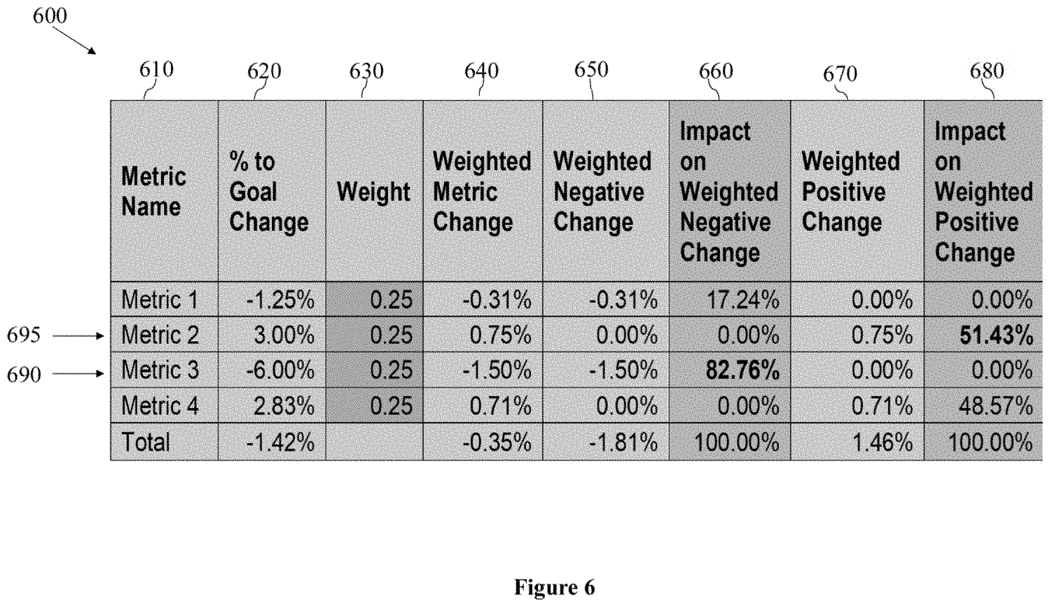

FIG. 6 is a table 600 showing an example of a calculation of the influence of each metric on the calculated change in KPI, in accordance with some embodiments of the present disclosure.

According to some embodiments of the present disclosure, to point down to the most influencer metric on a measured performance change, an analysis may be performed over metrices.

According to some embodiments of the present disclosure, the KPI may be constructed of four equally weighted metrices, e.g., a weight of 0.25 is given per each metric. In a non-limiting example, the Weighted Metric Change 640 is the product of Goal Change 620 with its corresponding Weight 630. Subsequently, Weighted Impact Negative and Positive 650 and 670 respectively, may be achieved by normalizing a Weighted Metric Change 640 by its sum.

$$Impact on Weighted Negative Change = \frac{Weighted Metric Change}{{\sum }_{i = 0}^{n} Weighted Metric {Change}_{i}} where i = 1 , 2 … n ∀ Weighted Metric Change > 0$$

$$Impact on Weighted Negative Change = \frac{Weighted Metric Change}{{\sum }_{i = 0}^{n} Weighted Metric {Change}_{i}} where i = 1 , 2 … n ∀ Weighted Metric Change < 0$$

Where i represents the metric index

According to some embodiments of the present disclosure, a user such as a Senior manager can assign one or more metrics to a KPI. Column 610 shows four metrics. Column 620 shows the percentage to goal change between two periods, past and current periods. Column 630 shows that each metric has been assigned an equal weight of 0.25%. Column 640 is a calculated weighted percentage to goal metric change. Column 650 shows the weighted negative change of each metric. Column 660 shows the impact of each metric on the weighted negative change. Column 670 shows the weighted positive change of each. metric. Column 680 shows the impact of each metric on the weighted positive change.

In the non-limiting example, metric 3 shown by element 690 is the most negatively influential with ‘82.76%’ in Impact on Weighted Negative Change column 660. On the other hand, metric 2 shown by element 695 is the most positively influential with ‘51.43%’ in Impact on Weighted Positive Change column 680.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should he understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure,

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fill within the true spirit of the disclosure.

1. A computerized method for automatically pointing on an influencer on a measured performance change, the computerized method comp using:
receiving one or more metrics from a. user to construct a Key Performance Indicator (KPI);
retrieving data related to one or more agents during a predefined period for the one or more metrics from one or more performance management databases;
calculating a change in KPI:
when the calculated change in KPI is negative:
calculating an influence of each metric on the calculated change in KPI;
calculating an influence of each agent on the calculated change in KPI;
checking each agent having a negative change of a goal accomplished percentage, to downgrade a contribution factor of an agent having a top negative influence on the calculated change in KPI; and
forwarding the downgraded contribution factor of the agent having the top negative influence on the calculated change in KPI to a downstream application,
wherein the downstream application is selected from at least one of: (i) Automatic Call Distributor (ACD) system for call routing; and (ii) Workforce Management (WFM) system for shift-scheduling of agents.

2. The computerized method of claim 1, wherein the computerized method further comprising calculating a KPI for a specified period by:
for each metric:
a. receiving a weight;
b. for each agent of the one or snore agents:
(i) harvesting a performance score based on the retrieved data during, the specified period;
(ii) calculating a percentage of each determined performance score out of a predefined goal-value in the specified period, to yield the goal accomplished percentage; and
storing the goal accomplished percentage in the one or more performance management databases,
c. calculating an average goal accomplished percentage for all the agents during the specified period; and
d. storing the average goal accomplished percentage for all agents in the one or more performance management databases,
calculating a weighted sum of the one or more metrics based on the weight of each metric to yield the KPI.

3. The computerized method of claim 2, wherein the specified period includes two specified periods:
(i) past period and (ii) current period, and
wherein the calculating of the change in KPI is performed by:
calculating a KPI for the past period;
calculating a KPI for the current period; and
subtracting the KPI of the past period from the KPI of the current period to yield the change in the KPI.

4. The computerized method of claim 3, Wherein the calculating of the influence of each agent on the calculated change in KPI is further performed by:
for each agent:
retrieving the goal accomplished percentage from the one or more performance management databases for the past period and the current period;
calculating a total positive change and a total negative change between the retrieved past goal accomplished percentage and the retrieved current goal accomplished percentage;
calculating a change of goal accomplished percentage by subtracting the retrieved past goal accomplished percentage from the retrieved current goal accomplished percentage;
for each agent having a negative change of goal accomplished percentage, determining the percentage of a negative change out of the total negative change;
for each agent having a positive change of goal accomplished percentage, determining the percentage of a positive change out of the total positive change.

5. The computerized method of claim 3, wherein the calculating of the influence of each metric on the calculated change in KPI is further performed by:
for each metric:
i) retrieving the goal accomplished percentage for all agents from the one or more performance management databases for the past period and the current period;
(ii) calculating a change of average goal accomplished percentage for all agents by subtracting the retrieved past goal accomplished percentage for all agents from the retrieved current goal accomplished percentage for all agents;
(iii) calculating a weighted metric change for each metric by multiplying each change of average goal accomplished percentage for all agents with a predefined weight;
calculating total negative change of goal accomplished percentage of all metrics having a negative change;
calculating total positive change goal accomplished percentage of all metrics having a positive change;
for each metric having a negative change of goal accomplished percentage, determining the percentage of a negative change out of the calculated total negative change; and
for each metric having a positive change of goal accomplished percentage, determining the percentage of a positive change out of the calculated total positive change, to yield the influence of each metric on the calculated change in KPI.

6. The computerized method of claim 2, wherein the goal-value is determined per at least one of: a predetermined period; an agent; a metric; a category; or an interaction type.

7. The computerized method of claim 1, wherein the calculating of the change in KPI is performed by subtracting a KPI of the predefined period from a predefined KPI-goal, based on the retrieved data.

8. The computerized method of claim 7, wherein the calculating of the influence of each agent on the calculated change in KPI is further performed by:
for each agent:
retrieving the goal accomplished percentage from the one or more performance management databases for the predefined period;
calculating a change by subtracting the retrieved goal accomplished percentage from the predefined KPI-goal,
for each agent having a negative change of goal accomplished percentage, determining the percentage of a negative change out of the total negative change; and
for each agent having a positive change of goal accomplished percentage, determining the percentage of a positive change out of the total positive change.

9. The computerized method of claim 8. wherein the calculating of the influence of each metric on the calculated change in KPI is further perforated by:
for each metric:
retrieving the average goal accomplished percentage for all agents front the one or more performance management databases for the. predefined period;
(ii) calculating a change of average goal accomplished :percentage for ail agents by subtracting the retrieved goal accomplished percentage from a predefined metric goal for all agents: and
(iii) calculating a weighted metric change for each metric by multiplying each change of average goal accomplished percentage for all agents with a predefined weight;
calculating total negative change of goal accomplished percentage of metrics having a negative change; and
calculating total positive change goal accomplished percentage of all metrics having a positive change,
for each metric having a negative change of goal accomplished percentage, determining the percentage of a negative change out of the calculated total negative change; and
for each metric having a positive change of goal accomplished percentage, determining the percentage of a positive change out of the calculated total positive change, to yield the influence of each metric on the calculated change in KPI.

10. The computerized method of claim 1, wherein the computerized method further comprising access to data related to the agent after retrieving the data from the one or more performance management databases and wherein the retrieved data. includes: contact center interactions and performance score of each agent in each metric and in each interaction type and channel type.

11. The computerized method of claim 2, wherein each agent is assigned a different we the calculating of the average goal accomplished percentage.

12. The computerized method of claim 1, wherein the computerized method further comprising
assigning a coaching session to the one or more agents to improve a metric having a highest negative influence on the calculated change in KPI.

13. A computerized system for automatically pointing on an influencer on a measured performance change, the computerized system comprising:
one or more performance management databases;
a memory to store the one or more performance management databases;
a display unit, and
a processor, said processor is configured to
receive one or more metrics from a user to construct a Key Performance Indicator (KPI);
retrieve data related to one or more agents during a predefined period for the one or more metrics from one or more performance management databases;
calculate a change in KPI:
when the calculated change in KPI is negative:
calculate an influence of each metric on the calculated change in KPI;
calculate an influence of each agent on the calculated change in KPI, check each agent having a negative change of a goal accomplished percentage, to downgrade a contribution factor of an agent having a top negative influence on the calculated change in KPI; and
forward the downgraded contribution factor of the agent having the top negative influence on the calculated change in KPI to a downstream application,
wherein the downstream application is selected from at least one of. (i) Automatic Call Distributor (ACD) system for call routing; and (ii) Workforce Management (WFM) system for shift-scheduling of agents.

14. The computerized system of claim 13, wherein the processor is calculating a KPI for a specified period by:
for each metric:
a. receive a weight:
b. for each agent of the one or more agents:
(i) harvesting a performance score based on the retrieved data during the specified period;
(ii) calculating a percentage of each determined performance score out of a predefined goal-value in the specified period, to the yield goal accomplished percentage; and
(iii) storing the goal accomplished percentage in the one or more performance management databases,
c. calculating an average goal accomplished percentage for all the agents in the specified period; and
d. storing the average goal accomplished percentage for all the agents in the one or more performance management databases,
calculating a weighted sum of the one or more metrics based on the weight of each metric to yield the KPI.

15. The computerized system of claim 14, wherein the predefined period includes two specified periods: (i) past period and (ii) current period, and
wherein the processor is configured to calculate the change in KPI by:
calculating a KPI for the past period;
calculating a KPI for the current period; and
subtracting the KPI of the past period from the KPI of the current period to yield the change in the KPI.

16. The computerized system of claim 15, wherein the processor is configured to calculate the influence of each agent on the calculated change in KPI by:
for each agent:
retrieving the goal accomplished percentage from the one or more performance management databases for the past period and the current period;
calculating the total positive change and the total negative change between the retrieved past goal accomplished percentage and the retrieved current goal accomplished percentage;
calculating a change of goal accomplished percentage by subtracting the retrieved past goal accomplished percentage from the retrieved current goal accomplished percentage;
for each agent having a negative change of goal accomplished percentage, determining the percentage of a negative change out of the total negative change;
for each agent having a positive change of goal accomplished percentage, determining the percentage of a positive change out of the total positive change.

17. The computerized system of claim 16, wherein the processor is configured to calculate the influence of each metric on the calculated change in KPI by:
for each metric:
(i) retrieving the goal accomplished percentage for all agents from the one or more performance management databases for the past period and the current period;
(ii) calculating a change of average goal accomplished percentage for all agents by subtracting the retrieved past goal accomplished percentage for all agents from the retrieved current goal accomplished percentage for all agents;
Oil) calculating a weighted metric change for each metric by multiplying each change of average goal accomplished percentage for all agents with a predefined weight;
calculating total negative change of goal accomplished percentage of all metrics having a negative change;
calculating total positive change goal accomplished percentage of all metrics having a positive change;
for each metric having a negative change of goal accomplished percentage, determining the percentage of a negative change out of the calculated total negative change; and
for each metric having a positive change of goal accomplished percentage, determining the percentage of a positive change out of the calculated total positive change, to yield the influence of each metric on the calculated change in KPI.

18. The computerized system of claim 14, wherein the goal-value is determined per at least one of: a predetermined period; an agent; a. metric: a category; or an interaction type.

19. The computerized system of claim 13, wherein the calculating of the change in KPI is performed by subtracting from KPI of the predefined period a predefined KPI-goal, based on the retrieved data.

20. The computerized system of claim 19, wherein the processor is configured to calculate the influence of each agent on the calculated change in KPI is further performed by:
for each agent:
retrieving the goal accomplished percentage from the one or more performance management databases for the predefined period;
calculating a change by subtracting the retrieved goal accomplished percentage from the predefined KPI-goal;
for each agent having a negative change of goal accomplished percentage, determining the percentage of a negative change out of the total negative change; and
for each agent having a positive change of goal accomplished percentage, determining the percentage of a positive change out of the total positive change.

21. The computerized system of claim 20. wherein the processor is configured to calculate the influence of each metric on the calculated change in KPI is further performed by:
for each metric:
(i) retrieving the average goal accomplished percentage for all agents from the one more performance management databases for the predefined period;
(ii) calculating a change of average goal accomplished percentage for all agents by subtracting the retrieved goal accomplished percentage from a predefined metric goal for all agents; and
(iii) calculating a weighted metric change for each metric by multiplying each change of average goal accomplished percentage for all agents with a predefined weight;
calculating total negative change of goal accomplished percentage of all metrics having a negative change; and
calculating total positive change goal accomplished percentage of all metrics having a positive change,
for each metric having a negative change of goal accomplished percentage, determining the percentage of a negative change out of the calculated total negative change; and
for each metric having a positive change of goal accomplished percentage, determining the percentage of a positive change out of the calculated total positive change, to yield the influence of each metric on the calculated change in KPI.

22. The computerized system of claim 13, wherein the processor is further configured to enable access to data related to the agent after retrieving the data from the one or more performance management databases and wherein the retrieved data includes: contact center interactions and performance score of each agent in each metric and in each interaction type and channel type.

23. The computerized system of claim 14, Wherein each agent is assigned a different weight for the calculating of the average goal accomplished percentage.

24. The computerized system of claim 13, wherein the processor is further configured to assign a coaching session to the one or more agents to improve a metric having a highest negative influence on the calculated change in KPI.
